(19) United States
(12) Patent Application Publication
(10) Pub. No.: US 2008/0273685 A1
(43) Pub. Date: Nov. 6, 2008

(54) METHOD AND APPARATUS FOR SEARCHING PHONE NUMBER USING FIGURE RECOGNITION IN PORTABLE TERMINAL

(75) Inventor: Jin CHOI, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/114,254

(22) Filed: May 2, 2008

(30) Foreign Application Priority Data
May 3, 2007 (KR) 2007-0042917

(51) Int. Cl. H04M 3/42

(52) U.S. Cl. 379/218.01

(57) ABSTRACT

A method and apparatus for searching a phone number using a figure recognition in a portable terminal is provided. The method includes mapping a specific figure to each phone number and storing the mapping result, receiving a specific figure from a user, searching a same figure as the received specific figure among previously stored figures, and identifying a phone number mapped to the searched figure.

### PRIORITY

This application claims priority under 35 U.S.C. §119(a) to an application filed in the Korean Intellectual Property Office on May 3, 2007 and assigned Serial No. 2007-42917, the contents of which are incorporated herein by reference.

### BACKGROUND OF THE INVENTION

1. Field of the Invention

The present invention relates generally to a method for searching a phone number using figure recognition in a portable terminal, and in particular, to a method and apparatus for mapping a specific figure to a phone number.

2. Description of the Related Art

Due to the convenience of its portability, the spread of portable terminals has dramatically increased in recent years. Accordingly, service providers and terminal manufacturers are having hard time developing terminals having more convenient functions to lure many users.

For example, portable terminals provide a function of quickly searching a phone number stored in the portable terminals using a shortcut key and attempting telephony. Portable terminals provide a function of mapping each phone number to a specific numeral, that is, a shortcut number, and storing the mapping result and upon press of a key corresponding to a shortcut number, quickly searching a phone number mapped to the shortcut number and attempting telephony.

When a user searches a phone number using a shortcut key in a portable terminal, he or she has to remember the shortcut key corresponding to the phone number to be searched. However, there is a drawback that a shortage of relationship between each phone number and a shortcut number mapped to the phone number makes it difficult for a user to memorize the shortcut number. Using the shortcut number has a shortfall in expressing a feature or a relationship with each phone number for a user to easily memorize the shortcut number mapped to each phone number.

### SUMMARY OF THE INVENTION

An aspect of the present invention is to solve at least the above problems and/or disadvantages and to provide at least the advantages described below. Accordingly, an aspect of the present invention is to provide a method and apparatus for searching phone number using figure recognition in a portable terminal.

Another aspect of the present invention is to provide a method and apparatus for mapping a phone number and a figure and facilitating a search for each phone number in a portable terminal.

The above aspects are achieved by providing a method and apparatus for searching phone number using figure recognition in a portable terminal.

According to one aspect of the present invention, a method for searching phone number using figure recognition in a portable terminal is provided. The method includes storing touch images corresponding to a phone number or a name, receiving a touch image from a user, analyzing the received touch image, searching a touch image corresponding to the analyzed touch image among previously stored images, and identifying the phone number or the name corresponded to the searched touch image.

According to another aspect of the present invention, an apparatus for searching phone number using figure recognition in a portable terminal is provided. The apparatus includes a storage unit for storing touch images corresponding to a phone number or a name, a touch pad receiving a touch image from a user, and a controller for, analyzing the received touch image, and searching a touch image corresponding to the analyzed touch image among the touch images previously stored in the storage unit and identifying the phone number or the name corresponded to the searched touch image.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram showing a portable terminal according to the present invention;

FIG. 2 is a flowchart showing a procedure of mapping and storing a phone number and a figure in a portable terminal according to the present invention;

FIG. 3 is a flowchart showing a procedure of searching a phone number using figure recognition in a portable terminal according to the present invention; and

FIG. 4 shows a screen scheme for searching a phone number using figure recognition in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A method and apparatus for mapping a specific figure to a phone number and storing the mapping result, and recognizing a specific figure inputted from a user and thus searching a phone number in a portable terminal will be described below. The figure signifies the inclusion of all figures such as a picture, a character, and a diagram.

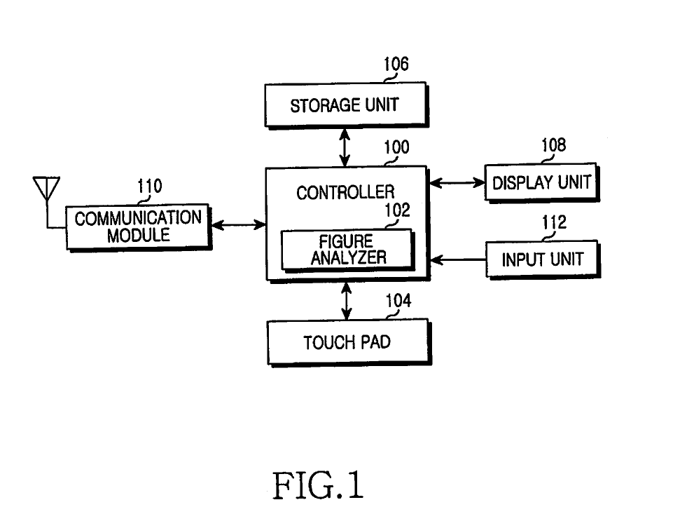

FIG. 1 is a block diagram showing a portable terminal according to the present invention. The portable terminal includes a controller 100, a figure analyzer 102, a touch pad 104, a storage unit 106, a display unit 108, a communication module 110, and an input unit 112.

Referring to FIG. 1, the controller (ex. Micro-Processor Unit (MPU)) 100 performs a process and a control for voice telephony and data communication of the portable terminal. In particular, the controller 100 including the figure analyzer 102 according to the present invention controls and processes a function of mapping a specific figure to each phone number and stores the mapping result, and analyzes and recognizes a specific figure inputted from a user and thus searches a phone number mapped to the specific figure.

In detail, upon occurrence of a figure set event for mapping a figure to a specific phone number, the figure analyzer 102 analyzes and recognizes a specific figure inputted from the touch pad 104, maps the recognized figure to a corresponding phone number, and outputs the mapping result to the storage unit 106. When the figure analyzer 102 receives a specific figure from the touch pad 104 in an idle state, the figure analyzer 102 analyzes and recognizes the received specific figure and checks if there is a same figure as the received specific figure among figures previously stored in the storage unit 106. When there is a same figure as the received specific figure in the storage unit 106, the figure analyzer 102 searches a phone number mapped to the same figure and outputs the searched phone number to the display unit 108. When there is no same figure as the received specific figure in the storage unit 106, the figure analyzer 102 outputs a message informing that there is no same figure or a message informing that there is no phone number corresponding to the received specific figure to the display unit 108. The figure analyzer 102 can also determine that the received figure is the same as a previously stored figure, regardless of being different size, thickness, etc., as long as it has the same shape as the previously stored figure.

The touch pad 104 can include a plurality of function keys. The touch pad 104 recognizes and provides a feature of touch operation by a user to the controller 100. Specifically, the touch pad 104 recognizes and provides a touch type of the touch pad 104, for example, a touched direction, a touched shape, and the number of times of touch to the controller 100 according to the present invention.

The storage unit 106 is comprised of a Read Only Memory (ROM), a Random Access Memory (RAM), and a flash ROM, and stores a microcode of program for processing and controlling the controller 100 and diverse reference data, temporary data generated in execution of the program, and diverse safekeeping data that is updateable. In particular, the storage unit 106 stores a phone number and a figure inputted from the controller 100 according to the present invention.

The display unit 108 displays status information generated in operation of the portable terminal, the limited number of characters, and a large amount of moving pictures and still pictures. Specifically, the display unit 108 displays a phone number inputted from the controller 100 and an associated function (e.g., voice telephony, video telephony, Short Message Service (SMS), Multimedia Message Service (MMS), E-Mail, or phonebook edition function) executable using the phone number. Also, the display unit 108 displays a message informing that there is not a same figure as a figure inputted from the controller or a message informing that there is no corresponding phone number.

The communication module 110 transceives and processes a radio data signal inputted and output through an antenna. For example, in a transmission mode, the communication module 110 processes transmission data by channel coding and spreading, converts a baseband signal into a Radio Frequency (RF) signal, and transmits the RF signal through the antenna. In a reception mode, the communication module 110 converts a received RF signal into a baseband signal and processes the baseband signal by de-spreading and channel-decoding for data restoration.

The input unit 112 includes a plurality of numeral keys and function keys and provides key input data associated with a key pressed by a user to the controller 100. Specifically, the input unit 112 provides a phone number input from a user and other information on the phone number to the controller 100 according to the present invention.

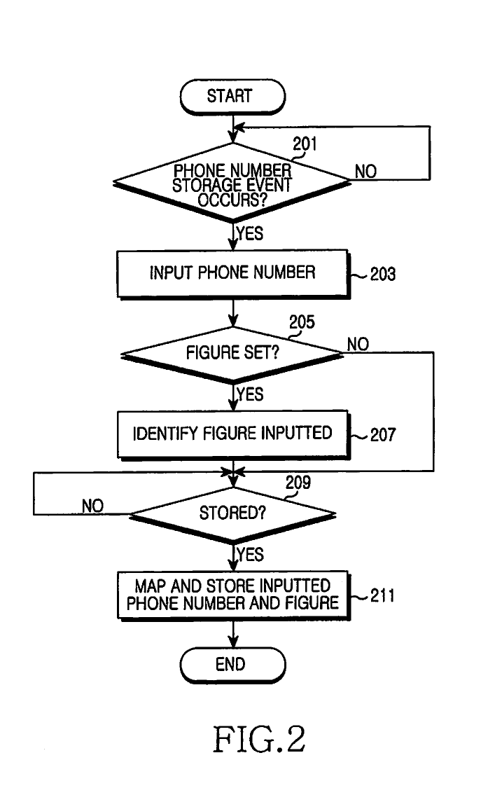

FIG. 2 is a flowchart showing a procedure of mapping and storing a phone number and a figure in a portable terminal according to the present invention.

Referring to FIG. 2, when a phone number storage event occurs in Step 201, the portable terminal receives a phone number from a user in Step 203. The portable terminal can also receive information other than the phone number, for example, information such as a name, an e-mail address, and a birthday when receiving the phone number.

In Step 205, the portable terminal checks if a figure set event for mapping a figure to the phone number occur.

When the figure set event does not occur, the portable terminal proceeds to Step 209 and when the figure set event does occur, the portable terminal proceeds to Step 207, analyzes and recognizes a figure input from a user through the touch pad 104.

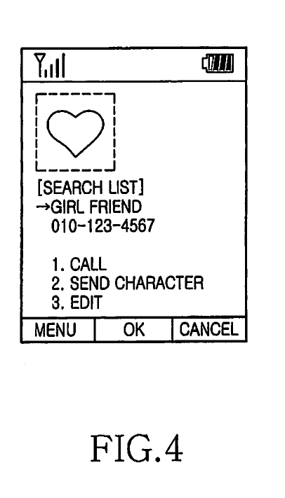

In Step 209, the portable terminal checks if a storage event occurs. When the storage event occurs, the portable terminal proceeds to Step 211, mapping and storing the received phone number and the received figure. For example, as shown in FIG. 4, in a case a user inputs a girl friend's phone number and other information, he/she can input a heart pattern figure as a figure for searching the girl friend's phone number quickly, mapping the heart pattern figure to the phone number and storing the mapping result.

After that, the portable terminal terminates the process according to the present invention.

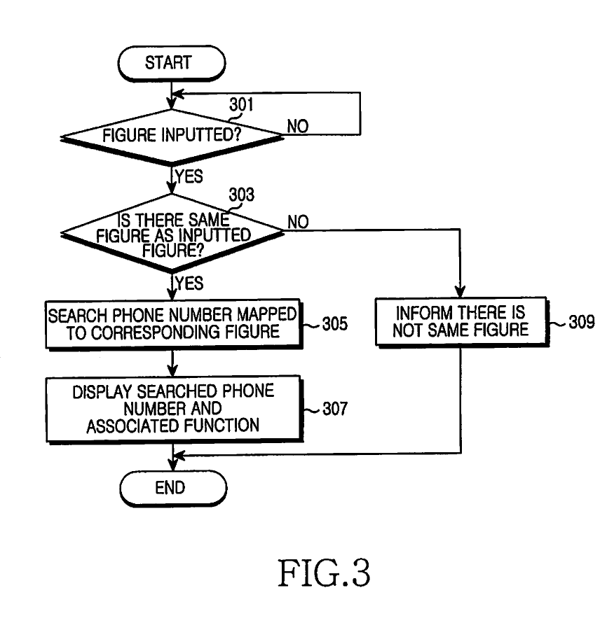

FIG. 3 is a flowchart showing a procedure of searching a phone number using figure recognition in a portable terminal according to the present invention.

Referring to FIG. 3, the portable terminal checks if a user touches the touch pad 104 and inputs a specific figure in Step 301. In a case the specific figure is input, the portable terminal analyzes and recognizes the inputted figure and checks if there is a same figure as the input figure among figures previously stored in the storage unit 106 in Step 303. The portable terminal can also determine that the input figure is the same as a previously stored figure, regardless of being different size, thickness, etc., as long as it has the same shape as the previously stored figure.

When there is a same figure as the input figure, the portable terminal proceeds to Step 305, searches the storage unit 106 for a stored phone number mapped to the same figure and displays the searched phone number and an associated function (e.g., voice telephony, video telephony, SMS, MMS, E-Mail, or phonebook edition) executable using the phone number.

For example, as shown in FIG. 4, when a user inputs a heart pattern figure, the portable terminal searches and displays a girl friend's phone number ‘010-123-4567’ mapped and stored with the heart pattern figure and displays an associated function executable using the phone number.

After that, the portable terminal terminates the process according to the present invention.

Alternatively, when there is no same figure as the inputted figure, the portable terminal proceeds to Step 309, displays a message informing that there is no same figure as the inputted figure or a message informing that there is no phone number mapped to the input figure. Next, the portable terminal terminates the process according to the present invention.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As described above, the present invention provides a method and apparatus for mapping a specific figure to a phone number and storing the mapping result, and recognizing a specific figure input from a user and thus searching and displaying a phone number. Thus, the present invention has an effect of assisting a user in setting a figure that is a good expression of a feature of a phone number to each phone number, easily memorizing the figure set corresponding to the phone number, and searching the phone number quickly using the figure.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for searching a phone number using a figure recognition in a portable terminal, the method comprising:
storing touch images corresponding to a phone number or a name;
receiving a touch image from a user;
analyzing the received touch image;
searching a touch image corresponding to the analyzed touch image among previously stored images; and
identifying the phone number or the name corresponded to the searched touch image.

2. The method of claim 1, further comprising displaying the identified phone number.

3. The method of claim 1, further comprising displaying a function executable using the identified phone number.

4. The method of claim 3, wherein the function executable using the phone number includes at least one of voice telephony, video telephony, Short Message Service (SMS), Multimedia Message Service (MMS), E-Mail, and phonebook edition functions.

5. The method of claim 1, wherein the searching a touch image corresponding to the analyzed touch image comprises:
checking if there is the touch image corresponding to the analyzed touch image among the previously stored figures; and
when there is not the same figure, displaying a message informing that there is no phone number corresponding to the received figure.

6. An apparatus for searching a phone number using a figure recognition in a portable terminal, the apparatus comprising:
a storage unit for storing touch images corresponding to a phone number or a name;
a touch pad receiving a touch image from a user; and
a controller for, analyzing the received touch image, and searching a touch image corresponding to the analyzed touch image among the touch images previously stored in the storage unit and identifying the phone number or the name corresponded to the searched touch image.

7. The apparatus of claim 6, further comprising a display unit for displaying the identified phone number and a function executable using the identified phone number.

8. The apparatus of claim 7, wherein the function executable using the phone number includes at least one of voice telephony, video telephony, Short Message Service (SMS), Multimedia Message Service (MMS), E-Mail, and phonebook edition functions.

9. The apparatus of claim 6, wherein the controller controls a function of displaying a message informing that there is no phone number corresponding to the received specific figure when there is not the same figure as the analyzed touch image among the previously stored figures.

10. A computer-readable recording medium having recorded hereon a program for searching a phone number using a figure recognition in a portable terminal, comprising:
a first code segment, for storing touch images corresponding to a phone number or a name;
a second code segment, for receiving a touch image from a user;
a third code segment, for analyzing the received touch image;
a fourth code segment, for searching a touch image corresponding to the analyzed touch image among previously stored images; and
a fifth code segment, for identifying the phone number or the name corresponded to the searched touch image.
